(19) United States
(12) Patent Application Publication
(10) Pub. No.: US 2014/0032282 A1
(43) Pub. Date: Jan. 30, 2014

(54) MODEL-BASED DYNAMIC PRICING FOR MANAGED LANES

(71) Applicant: Lina Fu, Fairport, NY (US)

(72) Inventor: Lina Fu, Fairport, NY (US)

(73) Assignee: XEROX CORPORATION, Norwalk, CT (US)

(21) Appl. No.: 13/557,714

(22) Filed: Jul. 25, 2012

(51) Int. Cl. G07B 15/06

(52) U.S. Cl. 705/13

(57) ABSTRACT

Methods and systems for dynamically determining a toll rate with respect to a high-occupancy toll road. A dynamic pricing controller can be configured to include one or more proactive components in association with one or more reactive component to determine the toll rate based on the real-time measurement and future prediction for the high-occupancy toll road. The controller is able to rapidly respond to real-time changes in the high-occupancy toll road and maintain a steady, free-flowing traffic with maximal throughput on the high-occupancy toll lanes.

### TECHNICAL HELD

Embodiments are generally related to HOT (High Occupancy Toll) roads and methods and systems for managing HOT roads and lanes. Embodiments are additionally related to monetizing and improving profits deriving from HOT roads and lands. Embodiments are further related to pricing algorithms and techniques for automatically determining toll rates in a HOT system and other managed lane techniques.

### BACKGROUND OF THE INVENTION

Managed lanes address traffic congestion by controlling access of vehicles to the highway facility. High occupancy toll (HOT) lanes are one form of managed lanes which charge toll for using the HOT facility. They have proved to be effective in improving the mobility and safety of the transportation system, while bringing in additional revenue.

Pricing algorithms are one of the keys to the effectiveness of HOT lanes. Some algorithms currently in use are static pricing algorithms, while others adopt a dynamic pricing strategy. Static pricing maintains a fixed toll rate or a predetermined toll table based on time of day and day of week. It cannot react to the real-time change in traffic conditions. On the other hand, dynamic pricing adjusts the toll rate in real time based on the observed traffic condition such as the speed and density on the HOT and general purpose lanes.

One example of a dynamic pricing is described in C. J. Robbins, Managed Lanes: A TMC Perspective, Ohio Transportation Engineering Conference, October 2009, which is incorporated herein by reference. This approach increases or decreases the toll based on observed traffic density. Other examples, such as those described U.S. Pat. Nos. 7,398,924 and 8,149,139, which are both incorporated herein by reference, determine the toll charge according to the observed change in speed and traffic flow on the HOT lanes. The algorithms disclosed in U.S. Pat. Nos. 7,398,924 and 8,149,139, however, are reactive in nature and do not account for the potential demand for the actual future time interval for which the toll is determined.

For linear systems, a reactive, linear feedback controller would work fine if designed properly. On the other hand, with nonlinear systems, a feedback controller usually needs to have high-gain to suppress the nonlinear dynamics. The high-gain component, however, in the system can lead to oscillation and even instability. Unfortunately, a HOT system is nonlinear and complex in nature. Therefore, more sophisticated designs are needed for HOT pricing control.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for methods and systems for dynamically determining a toll rate with respect to a high-occupancy toll road.

It is another aspect of the disclosed embodiments to provide for a model-based pricing approach for use in determining a toll rate to maximize the throughput on high-occupancy toll roads and lanes while maintaining free-flow condition.

The aforementioned aspects and other objectives and advantages can now be achieved as described herein. Methods and systems are disclosed for dynamically determining a toll rate with respect to a high-occupancy toll road. In general, a dynamic pricing controller can be configured to include one or more proactive components in association with one or more reactive component to rapidly respond to real-time changes and maintain a steady, maximal traffic flow for the high-occupancy toll road. The toll rate can be determined with respect to the high-occupancy toll road utilizing data generated by the pricing controller in order to maximize throughput on the high-occupancy toll road while maintaining a free flow-condition thereof.

Additionally, the controller structure for the pricing controller can be configured to allow for bottleneck management with respect to the high-occupancy toll road and maintain optimal traffic flow under stressed conditions thereof. The toll lanes associated with the high-occupancy toll road can include multiple access points. The pricing controller includes feedforward control data and feedback control data for use in calculating the toll rate. Also, the generation of bottleneck determination and target adjustment data can assist in the aforementioned bottleneck management.

A model-based pricing approach can thus be implemented for determining a toll rate dynamically to maximize the throughput on high-occupancy toll roads and lanes while maintaining free-flow condition. Such an approach can incorporate both proactive and reactive components to achieve fast response to real-time changes and maintain a steady, maximal traffic flow. The disclosed controller structure also allows active bottleneck management to maintain optimal traffic flow under stressed conditions.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a fundamental traffic flow diagram, in accordance with the disclosed embodiments;

FIG. 2 illustrates a block diagram depicting a feed-forward path in a pricing controller, in accordance with the disclosed embodiments;

FIG. 3 illustrates a block diagram depicting a feedback path, in accordance with the disclosed embodiments;

FIG. 4 illustrates a block diagram depicting a system for model-based dynamic pricing for managed lanes, in accordance with the disclosed embodiments;

FIG. 5 illustrates a graph depicting data that demonstrates the simulation results in terms of HOT throughput and total revenue for the two pricing algorithms, in accordance with the disclosed embodiments;

FIG. 6 illustrates a high-level flow chart of operations depicting logical operations of a method for model-based dynamic pricing for managed lanes, which can be implemented in accordance with the disclosed embodiments;

FIG. 7 illustrates a high-level flow chart of operations depicting logical operations of a process flow or method for a HOT management system, in accordance with the disclosed embodiments;

FIG. 8 illustrates a high-level flow chart of operations depicting logical operations of a process flow or method for a pricing controller, in accordance with the disclosed embodiments;

FIG. 9 illustrates a block diagram of a data-processing system that may be utilized to implement one or more embodiments; and

FIG. 10 illustrates a computer software system for directing the operation of the data-processing system depicted in FIG. 9, in accordance with an example embodiment.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The approach described herein augments a feedback controller with a feed-forward component, which is based on a model of the system and prediction on future input. The use of a feed-forward component enables faster response and less oscillation in the system state, while the feedback path eliminates the tracking error of the system state with respected to the target value.

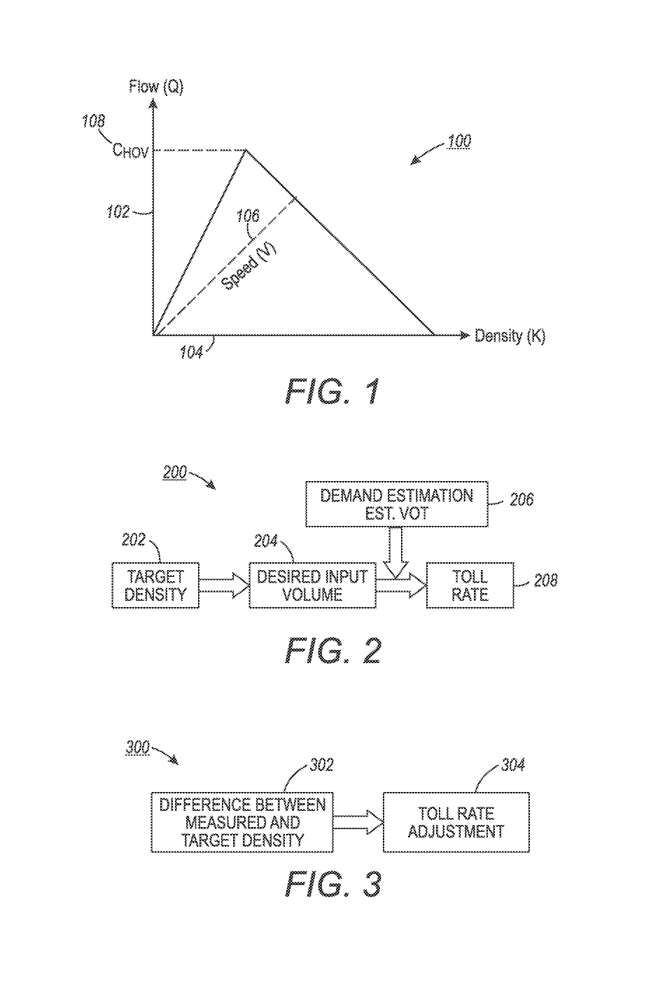

FIG. 1 illustrates a fundamental traffic flow diagram 100, in accordance with the disclosed embodiments. The graph or diagram 100 shown in FIG. 1 constitutes a simplified triangular flow-density diagram showing the density (K) along the x-axis 104 and flow (Q) along the y-axis 102. Speed (V) is shown in diagram 100 with respect to dashed line 106.

In general, a model-based pricing method, system, and processor-readable media can be employed for determining toll rate dynamically to maximize the throughput on the HOT lanes while maintaining free-flow condition. Such an approach incorporates both proactive and reactive components to achieve fast response to real-time changes and maintain a steady, maximal traffic flow. Traffic flow theory dictates that there is a critical flow density where the flow rate achieves a maximum with the free-flow speed, as indicated by diagram 100 shown in FIG. 1. Therefore, a pricing controller can be designed to regulate traffic density at a specified value. The target density is usually set close to the critical density and is reduced accordingly when bottlenecks occur on HOT lanes.

A system model is necessary to the prediction of the system in the future so that the future control action can be better determined. Freeway systems are complex and nonlinear in nature. A system model needs to capture at least two aspects: the traffic flow and the driver behavior. The traffic flow model connects the density K, speed V, and flow Q as expressed by the simplified triangular flow-density diagram depicted in FIG. 1 and the following equation:

K=Q/V (1)

Driver behavior is typically modeled by discrete choice model and is characterized in terms of value of time (VOT) and value of reliability (VOR) distribution. It is not realistic to obtain the true VOT and VOR distribution for each instantaneous group of drivers. However, an estimate can be made based on survey data in the area and/or historical traffic and toll data for the facility.

The information on the potential demand for the HOT lanes is also important towards predicting the system status. Data from upstream detectors, historical records on the proportion of exempt vehicles, and non-HOT eligible vehicles, as well as historical data on the typical trips through the facility can be used to construct an estimate of the upstream HOT demand in real-time.

FIG. 2 illustrates a block diagram depicting a feed-forward path 200 in a pricing controller, in accordance with the disclosed embodiments. As indicated in FIG. 2, a desired target density 202, a desired input volume 204, and demand estimation data 206 can be employed to determine tool rate data 208. The pricing controller for HOT lanes includes both feed-forward and feedback components. FIG. 2 illustrates the feed-forward path in the pricing controller. The feed-forward path 206 can be utilized to determine the base toll or toll rate 208 for the specified target density 202 on HOT lanes using current measurement and future prediction. First, the target density 202 is converted into desired input traffic volume 204 of HOT based on the flow speed measured at the entry of HOT. Then, given the estimated upstream traffic demand and the VOT distribution 206, the toll rate 208 can be calculated to attract the desired proportion of the demand into HOT lanes.

FIG. 3 illustrates a block diagram depicting a feedback path 300, in accordance with the disclosed embodiments. Thus, to compensate for the discrepancy between the estimated and the real-time demand and VOT distribution, the feedback component or path 300 can be introduced as shown in FIG. 3. The measured traffic density at the entry of HOT is compared to the target density, and the difference is taken to determine an adjustment amount to the base toll rate calculated above. The adjustment can be determined simply proportional to the value of the difference. One may also use a more sophisticated, nonlinear feedback mechanism.

The controller structure also allows active bottleneck management. Once a bottleneck emerges on the HOT lanes, it can be determined from the data measured in the upstream and downstream detectors. The target density can be reduced according to the bottleneck flow rate. The time delay to the bottleneck can also be considered by including appropriate delay time before the reduction of the target density. Active bottleneck management allows quick reaction to even slight congestion so as to ensure steady traffic flow on HOT.

Some freeway facilities allow vehicles to enter and exit the HOT lanes at the designated access points along the way. Some of them adopt a flat toll, where the drivers pay the same amount of fee regardless of where they exit. Another strategy used is mileage based tolling, where the toll increases with the traveling distance on the HOT lanes. In this case, one can consider the HOT segment with the heaviest traffic and determine the toll rate based on that segment. One may also use independent tolling for each HOT segment. Then each segment can be considered separately when determining the toll rate.

Note that in some embodiments, a commercial simulation platform such as Quadstone Paramics@ can be employed to conduct the simulation. Quadstone Paramics@ is a traffic microsimulation software developed by Quadstone Paramics. It can be appreciated of course that Quadstone Paramics@ is not a limiting feature of the disclosed embodiments, but is referred to herein only for example and edification purposes only. Thus, in one possible simulation, a road network can include two HOT lanes and four general-purpose lanes. During a 3-hour simulation, an incident in one HOT lane is scheduled to occur at 1 hour and 20 minutes, lasting for 25 minutes. The vehicles passing by are restricted to a passing speed of 10 MPH.

The result of the proposed controller can be compared to, for example, the Quadstone Paramics@ default pricing controller. The latter can utilize a reactive scheme based on the average traveling speed on the HOT. It increases the toll when the speed falls below the lower bound, and decreases the toll when it goes beyond the upper bound.

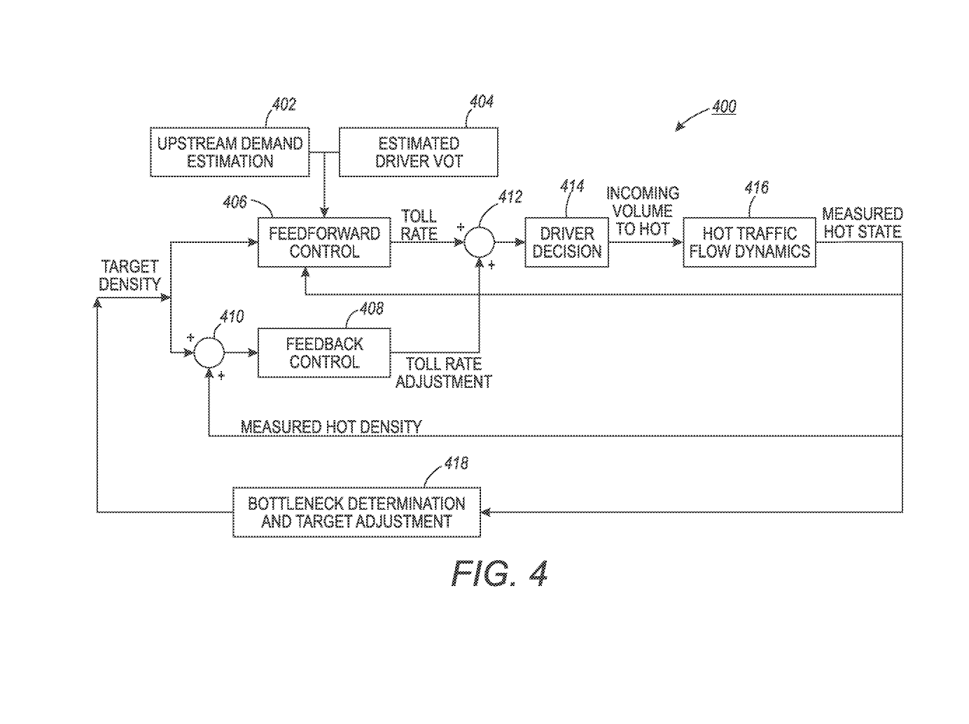

FIG. 4 illustrates a block diagram depicting a system 400 for model-based dynamic pricing for managed lanes, in accordance with the disclosed embodiments. In system 400, upstream demand estimation data 402 and estimated driver VOT data 404 can be provided as input to a feed forward control component 406 to calculate the toll rate, similar to the process shown in FIG. 2. Toll rate data output from the feed forward control 406 is included with toll rate adjustment data as indicated at summation block 412 and then provided as input to a driver decision component 414.

The result of driver decision 414 determines the incoming traffic volume to the HOT. This is the input to the HOT traffic flow dynamics 416. Note that the operations/blocks 414 and 416 shown in FIG. 4 represent a breakdown of the actual HOT system of interest, rather than part of the controller that is built. Measurements by devices such as loop detectors on the HOT can be provided to the feed forward control 406, summation block 410 (as measured HOT density data) and to a unit 418 that checks for bottleneck condition and adjusts the target density. Output from unit 418 constitutes target density data can be provided to the feed forward control 406 and the summation block 410. Output from the summation block 410 is fed to feedback control unit 408, which in turn outputs the toll rate adjustment data referred to earlier.

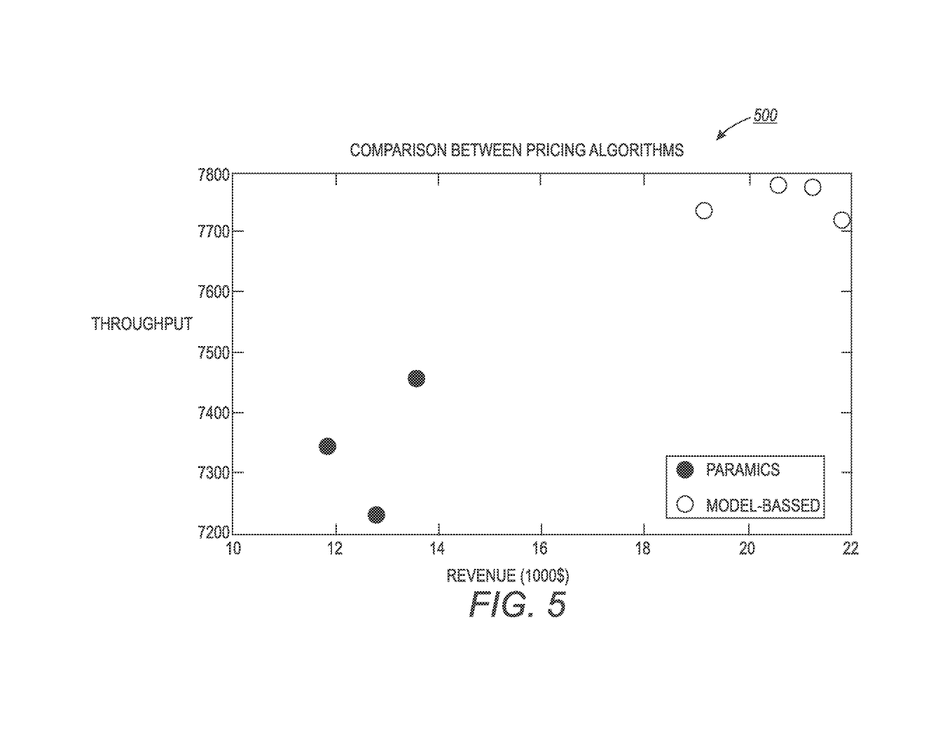

FIG. 5 illustrates a graph 500 depicting data that demonstrates the simulation results in terms of HOT throughput and total revenue for the two pricing algorithms, in accordance with the disclosed embodiments. Due to the stochastic nature of the simulation, several simulation runs were carried out for each algorithm. It is clear from the data indicated in graph 500 of FIG. 5 that the model-based algorithm enables significantly better HOT throughput and toll revenue. A legend indicates paramics data points and model-based data points, and thus compares pricing algorithms or approaches (i.e., paramics vs. model-based).

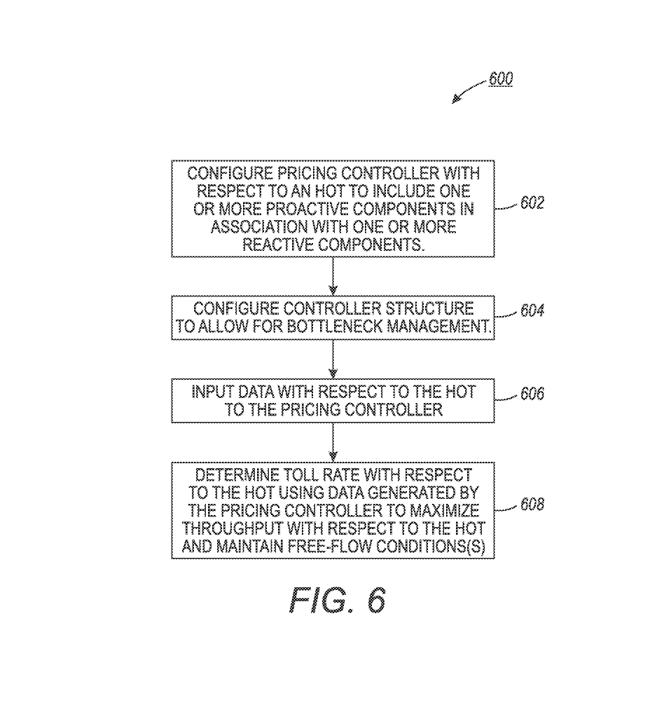

FIG. 6 illustrates a high-level flow chart of operations depicting logical operations of a method 600 for model-based dynamic pricing for managed lanes, which can be implemented in accordance with the disclosed embodiments. The method 600 can be utilized for dynamically determining the toll rate with respect to a HOT road/system (including HOT lanes, etc.). In general, as depicted at block 602, a pricing controller can be configured to include one or more proactive components in association with one or more reactive components to rapidly respond to real-time changes and maintain a steady, maximal traffic flow for the HOT road, system, lanes, etc.

As indicated thereafter at block 604, the controller structure can also be configured for bottleneck management. That is, the controller structure can include or involve logical operations for generating bottleneck determination and target adjustment data to assist in bottleneck management. Next, as shown at block 606, a step or logical operation can be implemented for automatically inputting data with respect to the HOT road/system of interest to the pricing controller. Thereafter, as shown at block 608, a step or logical operation can be implemented for determining the toll rate with respect to the HOT utilizing data generated by the pricing controller in order to maximize throughput on the HOT system/road, lanes, etc., while maintaining a free flow-condition thereof. Although not specifically shown in FIG. 6, it can be appreciated that the toll lane(s) associated with the HOT system/road can include multiple access points.

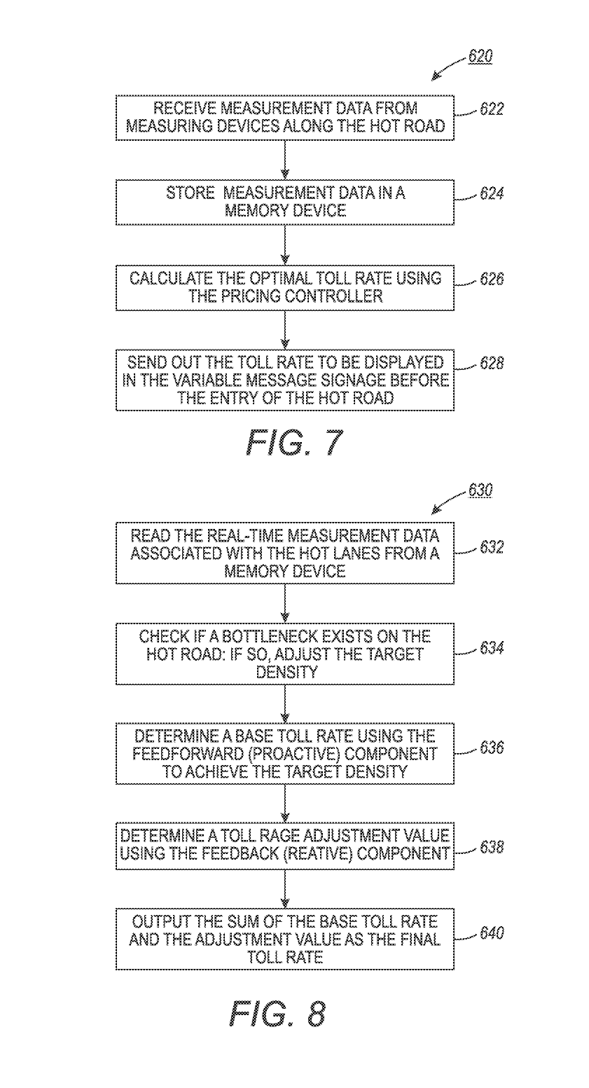

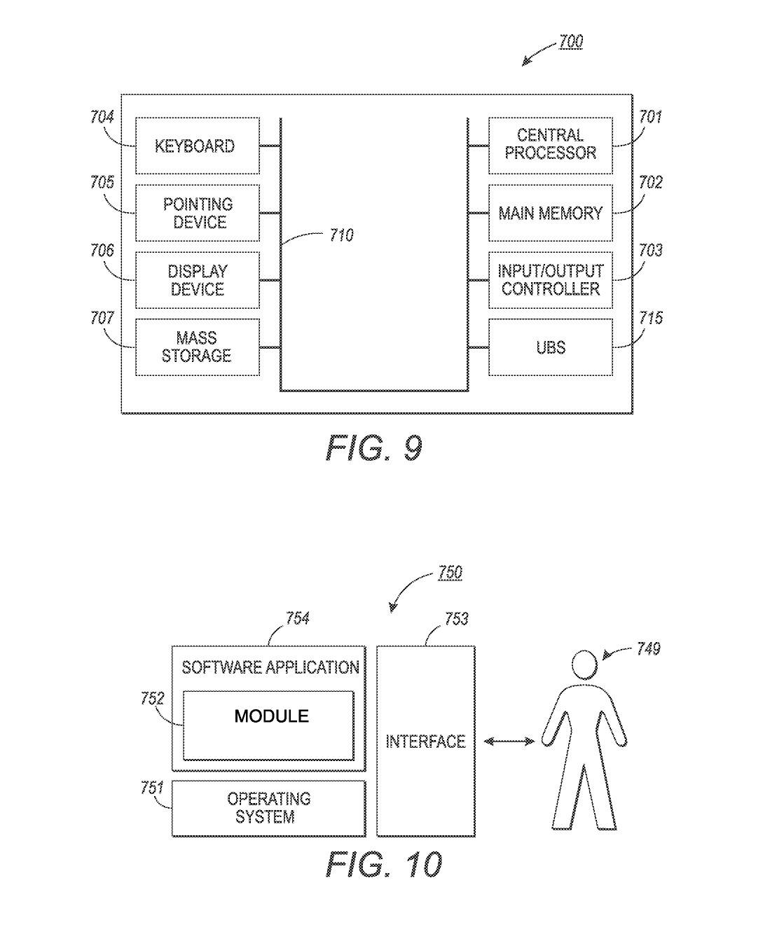

FIG. 7 illustrates a high-level flow chart of operations depicting logical operations of a process flow or method 620 for a HOT management system, in accordance with the disclosed embodiments. As indicated at block 622, a step or logical operation can be implemented for receiving measurement data from one or more measuring devices along a HOT road, highway or lane(s). Next, as depicted at block 624, a step or logical operation can be implemented for storing measurement data in a memory device. An example of a memory device is, for example, a memory such as the main memory 702 in FIG. 9. Thereafter, as described at block 626, a step or logical operation can be implemented for calculating the optimal toll rate using the pricing controller discussed herein. Next, as illustrated at block 628, a step or logical operation can be implemented for sending out or transmitting the toll rate (e.g., toll rate 208 shown in FIG. 3, toll rate+toll rate adjustment shown in FIG. 4, etc.) in variable message signage before entry to the HOT road, highway, lane(s), etc.

FIG. 8 illustrates a high-level flow chart of operations depicting logical operations of a process flow or method 630 for a pricing controller, in accordance with the disclosed embodiments. As indicated at block 632, a step or logical operation can be implemented for reading real-time measurement data associated with the HOT lanes from a memory device (e.g., main memory 702 of FIG. 9 or other types of memory components, etc.). Thereafter, as described at block 634, a step or logical operation can be implemented for determining if a bottleneck exists on the HOT road, highway, lane etc. If so, the target density can be adjusted. Next, as depicted at block 636, a step or logical operation can be implemented for determining a base toll rate using the feedforward (proactive) component to achieve the target density. Thereafter, as illustrated at block 638, a step or logical operation can be implemented for determining a toll rate adjustment value using the feedback (reactive) component. Next, as shown at block 640, a step or logical operation can be implemented to output the sum of the base toll rate and the adjustment value as the final toll rate.

As will be appreciated by one skilled in the art, the disclosed embodiments can be implemented as a method, data-processing system, or computer program product. Accordingly, the embodiments may take the form of an entire hardware implementation, an entire software embodiment or an embodiment combining software and hardware aspects all generally referred to as a “circuit” or “module.” Furthermore, the disclosed approach may take the form of a computer program product on a computer-usable storage medium having computer-usable program code embodied in the medium. Any suitable computer readable medium may be utilized including hard disks, USB flash drives, DVDs, CD-ROMs, optical storage devices, magnetic storage devices, etc.

Computer program code for carrying out operations of the present invention may be written in an object oriented programming language (e.g., JAVA, C++, etc.). The computer program code, however, for carrying out operations of the present invention may also be written in conventional procedural programming languages such as the “C” programming language or in a visually oriented programming environment such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiMax, 802.11x, and cellular network or the connection can be made to an external computer via most third party supported networks (e.g., through the Internet via an Internet service provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data-processing apparatus to produce a machine, such that the instructions, which execute via the processor of the computer or other programmable data-processing apparatus, create means for implementing the functions/acts specified in the block or blocks discussed herein such as, for example, the various instructions shown with respect to particular blocks in FIGS. 3, 4, 6, 7, 8.

These computer program instructions may also be stored in a computer-readable memory that can direct a computer or other programmable data-processing apparatus to function in a particular manner such that the instructions stored in the computer-readable memory produce an article of manufacture including instruction means which implement the function/act specified in the block or blocks.

The computer program instructions may also be loaded onto a computer or other programmable data-processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

FIGS. 9-10 are provided as exemplary diagrams of data-processing environments in which embodiments of the present invention may be implemented. It should be appreciated that FIG. 9-10 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 9, the disclosed embodiments may be implemented in the context of a data-processing system 700 that includes, for example, a central processor 701 (or other processors), a main memory 702, an input/output controller 703, and in some embodiments a USB (Universal Serial Bus) 715 or other appropriate peripheral connection. System 700 can also include a keyboard 704, an input device 705 (e.g., a pointing device such as a mouse, track ball, pen device, etc.), a display device 706, and a mass storage 707 (e.g., a hard disk). As illustrated, the various components of data-processing system 700 can communicate electronically through a system bus 710 or similar architecture. The system bus 710 may be, for example, a subsystem that transfers data between, for example, computer components within data-processing system 700 or to and from other data-processing devices, components, computers, etc.

FIG. 10 illustrates a computer software system 750, which may be employed for directing the operation of the data-processing system 700 depicted in FIG. 9. Software application 754, stored in main memory 702 and on mass storage 707 shown in FIG. 9, generally includes and/or is associated with a kernel or operating system 751 and a shell or interface 753. One or more application programs, such as module(s) 752, may be “loaded” (i.e., transferred from mass storage 707 into the main memory 702) for execution by the data-processing system 700. The data-processing system 700 can receive user commands and data through user interface 753 accessible by a user 749. These inputs may then be acted upon by the data-processing system 700 in accordance with instructions from operating system 751 and/or software application 754 and any software module(s) 752 thereof.

The following discussion is intended to provide a brief, general description of suitable computing environments in which the system and method may be implemented, Although not required, the disclosed embodiments will be described in the general context of computer-executable instructions, such as program modules, being executed by a single computer. In most instances, a “module” constitutes a software application.

Generally, program modules (e.g., module 752) can include, but are not limited, to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked personal computers, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

The interface 753 (e.g., a grahical user interface) can serve to display results, whereupon a user may supply additional inputs or terminate a particular session. In some embodiments, operating system 751 and interface 753 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 751 and interface 753. The software application 754 can include, for example, module(s) 752, which can include instructions for carrying out steps or logical operations such as those shown in FIGS. 2, 3, 4 and 6, 7, 8 herein.

FIGS. 9-10 are thus intended as examples and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms including Macintosh, Unix, Linux, and the like.

Based on the foregoing, it can be appreciated that a number of embodiments, preferred and alternative, are disclosed. For example, in one embodiment, a method for dynamically determining a toll rate with respect to a high-occupancy toll road can be implemented. Such a method can include, for example, the steps or logical operations of configuring a pricing controller to include at least one proactive component in association with at least one reactive component to rapidly respond to real-time changes and maintain a steady, maximal traffic flow for the high-occupancy toll road, and determining a toll rate using the pricing controller based on a real-time measurement and future prediction for the the high-occupancy toll road in order to maximize throughput on the high-occupancy toll road while maintaining a free flow-condition thereof.

In another embodiment, a step or logical operation can be implemented for configuring or providing a controller structure for the pricing controller to allow for bottleneck management with respect to the high-occupancy toll road and maintain optimal traffic flow under stressed conditions thereof. In some embodiments, the toll lanes associated with the high-occupancy toll road can include multiple access points. In other embodiments, a step or operation can be implemented for configuring the pricing controller to include feedforward control to calculate the toll rate. In yet another embodiment, a step or operation can be provided for automatically adjusting the toll rate further based on a toll rate adjustment generated by the feedback control. In still another embodiment, a step or operation can be implemented for generating bottleneck determination and target adjustment data to assist in the bottleneck management.

In another embodiment, a system can be implemented for dynamically determining a toll rate with respect to a high-occupancy toll road. Such a system can include, for example, a processor, a data bus coupled to the processor, and a computer-usable medium embodying computer code, the computer-usable medium being coupled to the data bus. The computer code can include instructions executable by the processor and configured for configuring a pricing controller to include at least one proactive component in association with at least one reactive component to rapidly respond to real-time changes and maintain a steady, maximal traffic flow for the high-occupancy toll road, and determining a toll rate using the pricing controller based on a real-time measurement and future prediction for the high-occupancy toll road in order to maximize throughput on the high-occupancy toll road while maintaining a free flow-condition thereof.

In another embodiment, such instructions can be further configured to provide a controller structure for the pricing controller that allows for bottleneck management with respect to the high-occupancy toll road while maintaining optimal traffic flow under stressed conditions thereof. As indicated above, the toll lanes associated with the high-occupancy toll road can include multiple access points. In still another embodiment, such instructions can be further modified for configuring the pricing controller to include feedforward control to calculate the toll rate. In yet another embodiment, such instructions can be further configured for automatically adjusting the toll rate based on a toll rate adjustment generated by the feedback control. In other embodiments, such instructions can be configured for generating bottleneck determination and target adjustment data to assist in the bottleneck management.

In another embodiment, a processor-readable medium storing code representing instructions to cause a process to dynamically determine a toll rate with respect to a high-occupancy toll road can be implemented. In some embodiments, such code can include code to, for example, configure a pricing controller to include at least one proactive component in association with at least one reactive component to rapidly respond to real-time changes and maintain a steady, maximal traffic flow for the high-occupancy toll road; and determine a toll rate using the pricing controller based on a real-time measurement and future prediction for the high-occupancy to road in order to maximize throughput on the high-occupancy toll road while maintaining a free flow-condition thereof.

In some embodiments, such code can further include code to configure a controller structure for the pricing controller to allow for bottleneck management with respect to the high-occupancy toll road and maintain optimal traffic flow under stressed conditions thereof. In other embodiments, such code can further include code to configure the pricing controller to include feedforward control to calculate the toll rate. In other embodiments, such code can further include code to automatically adjust the toll rate further based on a toll rate adjustment generated by the feedback control. In other embodiments, such code can further include code to generate bottleneck determination and target adjustment data to assist in the bottleneck management.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for dynamically determining a toll rate with respect to a high-occupancy toll road, said method comprising:
configuring a pricing controller to include at least one proactive component in association with at least one reactive component to rapidly respond to real-time changes and maintain a steady, maximal traffic flow for said high-occupancy toll road; and
determining a toll rate using said pricing controller based on a real-time measurement and future prediction for said high-occupancy toll road in order to maximize throughput on said high-occupancy toll road while maintaining a free flow-condition thereof.

2. The method of claim 1 further comprising configuring a controller structure for said pricing controller to allow for bottleneck management with respect to said high-occupancy toll road and maintain optimal traffic flow under stressed conditions thereof.

3. The method of claim 1 wherein toll lanes associated with said high-occupancy toll road includes multiple access points.

4. The method of claim 1 further comprising configuring said pricing controller to include feedforward control to calculate said toll rate.

5. The method of claim 4 further comprising automatically adjusting said toll rate further based on a toll rate adjustment generated by said feedback control.

6. The method of claim 2 further comprising generating bottleneck determination and target adjustment data to assist in said bottleneck management.

7. The method of claim 2 wherein toll lanes associated with said high-occupancy toll road includes multiple access points.

8. A system for dynamically determining a toll rate with respect to a high-occupancy toll road, said system comprising:
a processor;
a data bus coupled to said processor; and
a computer-usable medium embodying computer code, said computer-usable medium being coupled to said data bus, said computer code comprising instructions executable by said processor and configured for:
configuring a pricing controller to include at least one proactive component in association with at least one reactive component to rapidly respond to real-time changes and maintain a steady, maximal traffic flow for said high-occupancy toll road; and
determining a toll rate using said pricing controller based on a real-time measurement and future prediction for said high-occupancy toll road in order to maximize throughput on said high-occupancy toll road while maintaining a free flow-condition thereof.

9. The system of claim 8 wherein said instructions are further configured to provide a controller structure for said pricing controller that allows for bottleneck management with respect to said high-occupancy toll road while maintaining optimal traffic flow under stressed conditions thereof.

10. The system of claim 8 wherein toll lanes associated with said high-occupancy toll road includes multiple access points.

11. The system of claim 8 wherein said instructions are further modified for configuring said pricing controller to include feedforward control to calculate said toll rate.

12. The system of claim 11 wherein said instructions are further configured for automatically adjusting said toll rate based on a toll rate adjustment generated by said feedback control.

13. The system of cairn 9 wherein said instructions are further configured for generating bottleneck determination and target adjustment data to assist in said bottleneck management.

14. The system of claim 9 wherein toll lanes associated with said high-occupancy toll road includes multiple access points.

15. A processor-readable medium storing code representing instructions to cause a process to dynamically determine a toll rate with respect to a high-occupancy toll road, said code comprising code to:
configure a pricing controller to include at least one proactive component in association with at least one reactive component to rapidly respond to real-time changes and maintain a steady, maximal traffic flow for said high-occupancy toll road; and
determine a toll rate using said pricing controller based on a real-time measurement and future prediction for said high-occupancy toll road in order to maximize throughput on said high-occupancy toll road while maintaining a free flow-condition thereof.

16. The processor-readable medium of claim 1, wherein said code further comprises code to configure a controller structure for said pricing controller to allow for bottleneck management with respect to said high-occupancy toll road and maintain optimal traffic flow under stressed conditions thereof.

17. The processor-readable medium of claim 15 wherein toll lanes associated with said high-occupancy toll road include multiple access points.

18. The processor-readable medium of claim 15 wherein said code further comprises code to configure said pricing controller to include feedforward control to calculate said toll rate.

19. The processor-readable medium of claim 18 wherein said code further comprises code to automatically adjust said toll rate further based on a toll rate adjustment generated by said feedback control.

20. The processor-readable medium of claim 16 wherein said code further comprises code to generate bottleneck determination and target adjustment data to assist in said bottleneck management.
